(19) United States
(12) Patent Application Publication
(10) Pub. No.: US 2012/0143407 A1
(43) Pub. Date: Jun. 7, 2012

(54) METHOD AND SYSTEM FOR RAIL VEHICLE CONTROL

(76) Inventor: Srinand Sridhara MURTHY, Bengaluru (IN)

(21) Appl. No.: 12/960,480

(22) Filed: Dec. 4, 2010

(51) Int. Cl. G05D 1/00; B60T 8/00

(52) U.S. Cl. 701/19

(57) ABSTRACT

Methods and systems are provided for train systems. One example system includes a rail vehicle, a mechanically-adjustable valve coupled in the rail vehicle having a plurality of positions, a pressure switch coupled to the mechanically-adjustable valve, an output of the pressure switch based on the position of the mechanically-adjustable valve, and a controller positioned in the rail vehicle and coupled to the pressure switch, the controller including code for setting an operational status of the rail vehicle in the train system based on the output of the pressure switch.

### FIELD

Embodiments of the subject matter disclosed herein relate to rail vehicles. Other embodiments relate to methods and systems for controlling a rail vehicle engine system or other rail vehicle system.

### BACKGROUND

Train consists can be configured with one or more locomotives (or other rail vehicles) and one or more cars. The one or more locomotives can include a lead locomotive and a trail locomotive. The one or more locomotives can be operated with idle reduction strategies, such as using automatic engine shutdown and restart operations, sometimes referred to as automatic engine start/stop (AESS) operations, to reduce the amount of time a locomotive engine is kept idling, thereby increasing system efficiency.

Newer locomotives include integrated electronic braking systems (such as integrated electronic air brake systems, EAB) in communication with an integrated function computer (IFC). The integrated electronic braking system is capable of determining and relaying an operational status of the locomotive (e.g., status for distributed power operations, and/or positional status), as set by an operator through the integrated function computer, to a locomotive controller. The locomotive controller includes software that adjusts locomotive engine operations, such as locomotive engine automatic start-stop operations, based on the relayed operational status of the locomotive. However, older locomotives lacking such integrated electronic braking systems are unable to determine and relay the operational status automatically to a locomotive controller. Consequently, the benefits of one or more engine operations that are based on the operational status of the locomotive (such as engine start-stop operations) may not be availed.

### BRIEF DESCRIPTION

Methods, systems, and computer readable media are provided for operating a rail vehicle in a consist. In one embodiment, a method comprises receiving an output from a sensor, wherein the output is based on a current position and/or a current pressure of a mechanically-adjustable valve in the rail vehicle. The method further comprises setting an operational status of the rail vehicle in the consist to one of a lead status or a remote status based on the output of the sensor. The method further comprises adjusting automatic engine shutdown and restart operations of the rail vehicle based on the operational status.

In another embodiment, a rail vehicle system comprises a mechanically-adjustable valve, a pressure switch, and a controller. The mechanically-adjustable valve is coupled in a rail vehicle, and has a plurality of positions. The pressure switch is coupled to the mechanically-adjustable valve. An output of the pressure switch is based on the position of the mechanically-adjustable valve. The controller is positioned in the rail vehicle and coupled to the pressure switch. The controller is configured for setting an operational status of the rail vehicle in a rail vehicle consist based on the output of the pressure switch.

In this way, an operational status of a rail vehicle is set by a controller based on the output of a sensor coupled to a mechanically-adjusted valve of the rail vehicle (such as a multi-purpose MU valve), even when the rail vehicle is not configured with integrated features capable of directly communicating the rail vehicle's operational status. By setting the rail vehicle's operational status in a consist, engine operations can be tailored to the operational status of the rail vehicle, allowing vehicle operations to be improved. For example, by tailoring engine automatic engine start/stop (AESS) operations for a rail vehicle engine based on the lead or remote status of the rail vehicle, fuel savings and emissions reduction benefits can be achieved even on older rail vehicles.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows an example embodiment of a rail vehicle consist including a plurality of rail vehicles;

FIGS. 2-3 show example embodiments of a mechanically-adjustable valve and a coupled pressure switch that may be used to communicate the operational status of the rail vehicle of FIG. 1 to a controller;

FIGS. 4-5 show high level flow charts of a method for setting an operational status of a rail vehicle;

FIG. 6 shows a high level flow chart of a method for adjusting engine AESS operations of a rail vehicle based on the operational status of the rail vehicle.

FIG. 7 shows a schematic diagram of a rail vehicle system, according to another embodiment of the invention.

Like reference characters designate identical or corresponding components and units throughout the several views, which are not to scale unless otherwise indicated.

### DETAILED DESCRIPTION

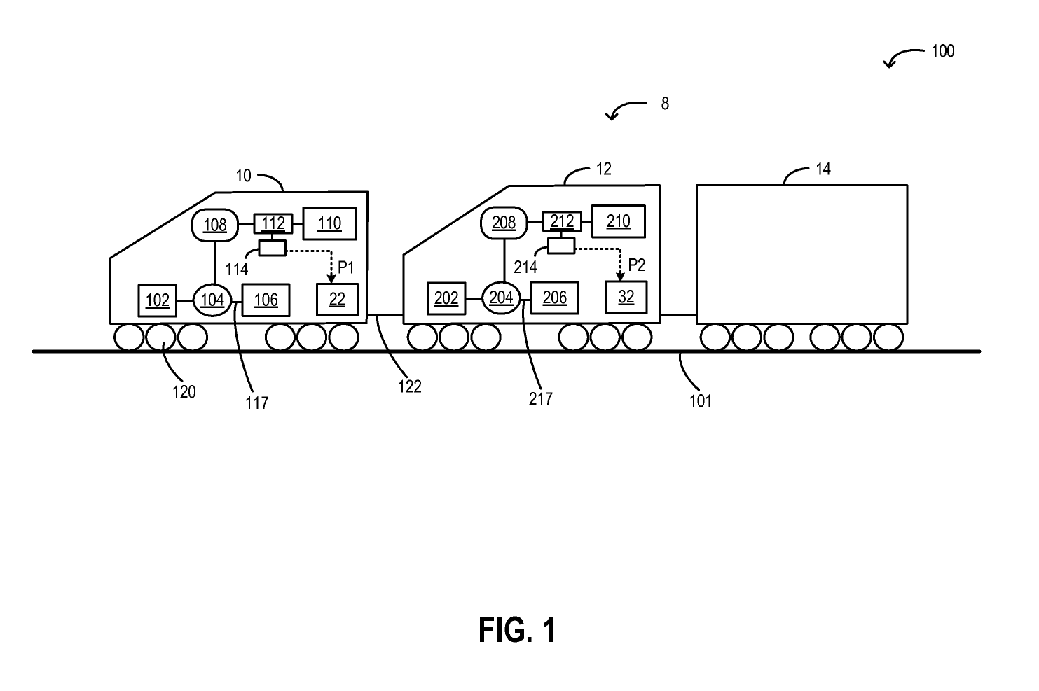

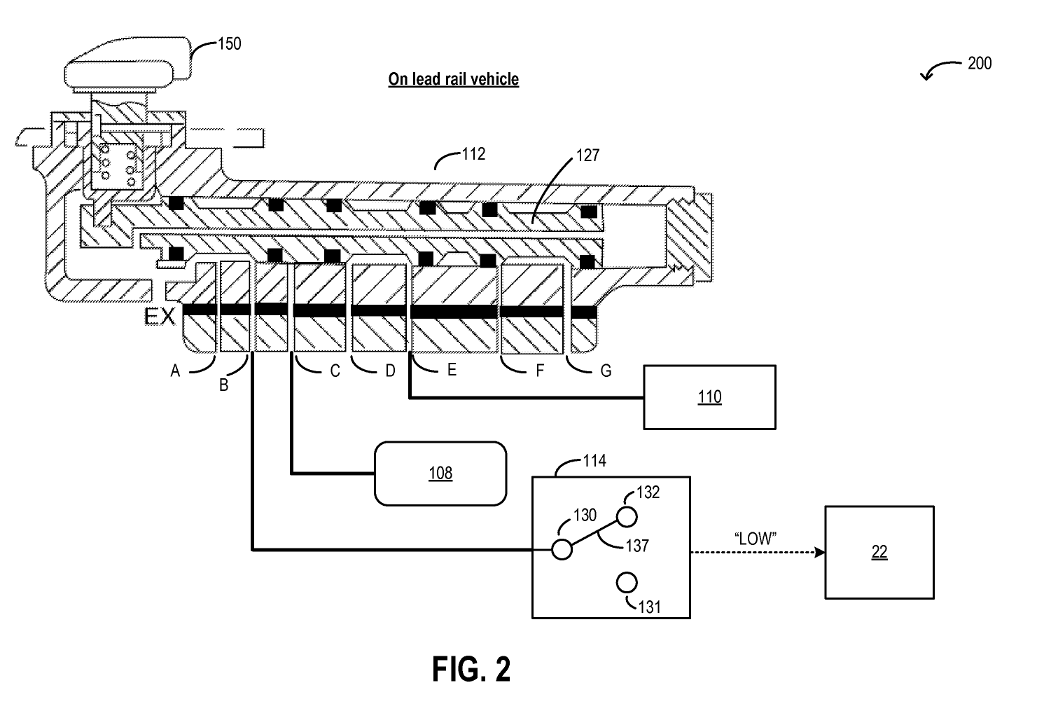

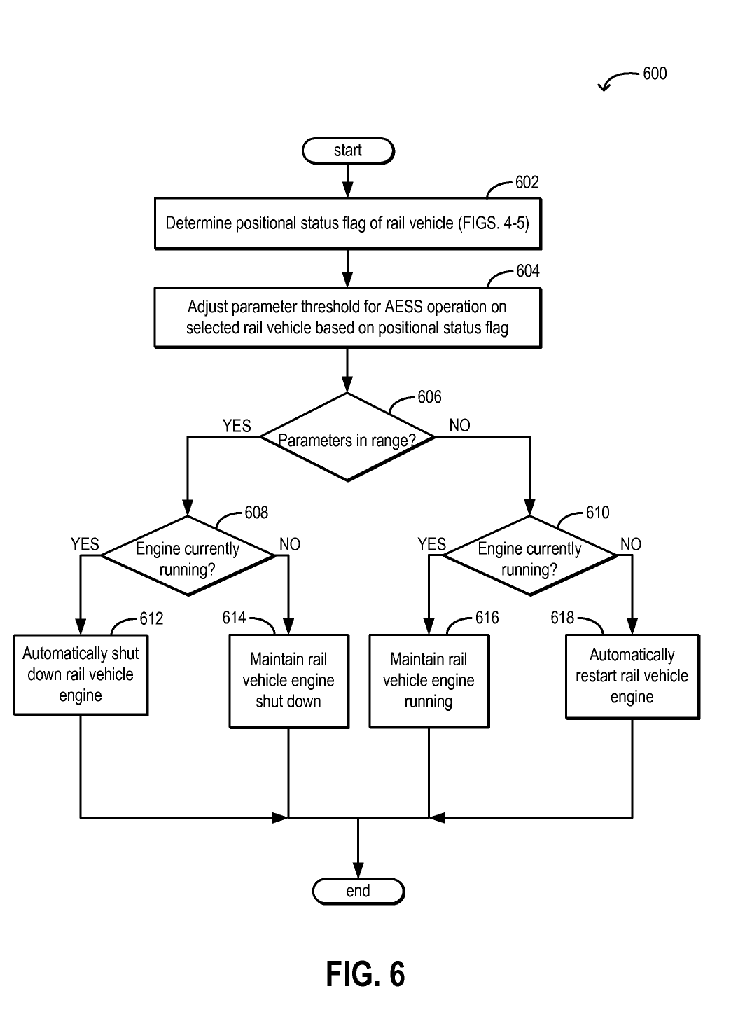

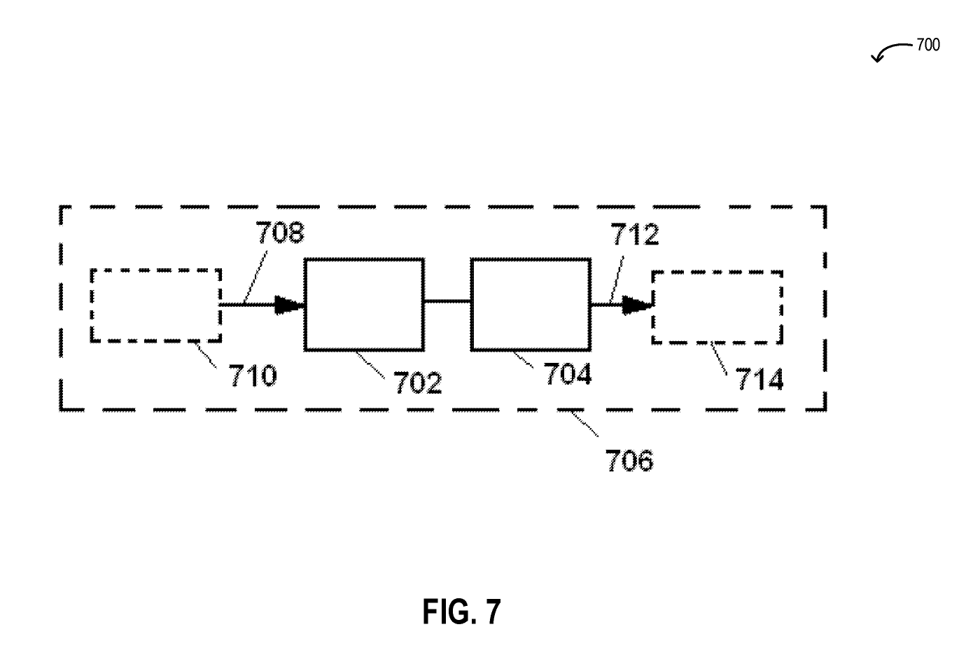

Trains, or other rail vehicle consists, may be configured with one or more locomotives, or other rail vehicles. One example configuration is illustrated in FIG. 1, wherein a train system includes a first rail vehicle in a lead status and a second rail vehicle in a remote status. The rail vehicles include respective on-board controllers configured with software enabling fuel savings operations, such as automatic engine start/stop (AESS) operations, that improve vehicle efficiency by reducing idling times, thereby enabling fuel savings and emissions reduction. However, one or more of the rail vehicles may be an older rail vehicle lacking integrated function features (such as integrated electronic air brake systems) capable of communicating the operational status (that is, lead or remote operational status) of the rail vehicle to a controller. As shown in FIGS. 2-5, a controller is configured to set an operational status (e.g., status flag) of an older rail vehicle based on an output from a sensor (e.g., a pressure switch) coupled to a mechanically-adjustable valve in the rail vehicle. The mechanically-adjustable valve has a plurality of positions (e.g., a first lead position and a second remote position). A position of the valve may be mechanically set, for example, manually set by a vehicle operator. An output of the sensor is based on the current position of the mechanically-adjusted valve. Based on the output of the sensor, a controller is configured to set an operational status setting of the rail vehicle to either a lead status or a remote status, and to further adjust engine operations for the rail vehicle accordingly (such as engine AESS operations, as shown in FIG. 6). In some embodiments, such as shown in FIG. 7, each rail vehicle may include one or more modules, such as an input module for receiving a signal regarding the position of the mechanically-adjustable valve in the rail vehicle, as well as a control module for generating a signal indicative of the operational status of the rail vehicle. By electronically communicating the operational status via a mechanically-adjusted valve and a coupled sensor, engine operations can be tailored for each rail vehicle based on the operational status, even on older locomotives.

FIG. 1 is a schematic diagram of an example embodiment of a rail vehicle system 100, herein depicted as consist 8, configured to travel on track 101. The rail vehicle system 100 is a multiple-unit rail vehicle system including a plurality of rail vehicles (e.g., locomotives), herein a first rail vehicle 10 and a second rail vehicle 12. The first rail vehicle 10 and the second rail vehicle 12 represent rail vehicles that provide tractive effort to propel the consist 8. In one example, the plurality of rail vehicles are diesel-electric vehicles that each include a diesel engine (102, 202) that generates a torque output that is converted to electricity by an alternator (not shown) for subsequent propagation to a variety of downstream electrical components, such as a plurality of traction motors (not shown) to provide tractive power to propel the rail vehicle system 100. In the depicted example, rail vehicles 10 and 12 may be operated with distributed power wherein first rail vehicle 10 has a lead operational status and second rail vehicle 12 has a remote operational status.

Although only two rail vehicles are depicted, it will be appreciated that the train system may include more than two rail vehicles. Furthermore, the rail vehicle system 100 may include rolling stock that does not provide power to propel the rail vehicle system 100. For example, the first lead rail vehicle 10 and the second remote rail vehicle 12 may be separated by a plurality of units (e.g., passenger or freight cars 14) that do not provide propulsion. On the other hand, every unit in the multiple-unit rail vehicle system may include propulsive system components that are controllable from a single location.

Operating crew and electronic components involved in rail vehicle systems control and management for each rail vehicle are housed within a rail vehicle cab. These include, for example, a first on-board controller 22 coupled in first rail vehicle 10 and a second on-board controller 32 coupled in second rail vehicle 12. In one example, on-board controllers 22, 32 include a computer control system comprising computer readable storage media including non-transitory code with instructions for enabling an on-board monitoring of rail vehicle operations (e.g., on-board diagnostics). On-board controllers 22, 32, overseeing rail vehicle systems control and management, are configured to receive signals from a variety of sensors. The various sensors may include, for example, coupler sensors, track grade sensors, temperature sensors, pressure sensors, tractive effort sensors, and the like, coupled to each respective rail vehicle. Based on the signals received from the various sensors of a given rail vehicle, various operating parameters for the given rail vehicle are adjusted, including, for example, a notch setting, engine injection timing, power distribution between rail vehicles, speed limits, AESS settings, etc. On-board controller 22, 32 may be further linked to a display (not shown), such as a diagnostic interface display, providing a user interface to the operating crew. On-board controller 22, 32 may also be configured to perform an AESS operation on an idle rail vehicle 10, 12, thereby enabling engine 102, 202 to be automatically stopped (or started) during AESS opportunities.

In some embodiments, the on-board controller 22, 32 may be in communication with a remote controller, for example, through wireless communication. The remote controller may be housed at a distant location, such as at a dispatch center. On-board controller 22, 32 may relay information, such as details of AESS operations performed, to the remote controller. The AESS details may be stored in an AESS database (in on-board controller 22, 32 and/or the remote controller) and may be used to compute AESS statistics, AESS credits, AESS credit histories, AESS implementation plans, locomotive performance plan, etc. Thus, the remote controller may assist on-board controller 22, 32 in determining operating parameters for rail vehicle system 100 during its mission based on estimated and/or predicted operating conditions. Further, the remote controller may be configured to coordinate operation of rail vehicle system 100 with other trains, rail vehicles, and/or locomotives in the fleet.

Engines 102, 202 generate a torque that is transmitted to an alternator along a drive shaft. The generated torque is used by the alternator to generate electricity for subsequent propagation of the vehicle. Engines 102, 202 may be run at a constant speed, thereby generating a constant horsepower (hp) output, or at variable speed generating variable horsepower output, based on operational demand. The electrical power may be transmitted along an electrical bus 117, 217 to a variety of downstream electrical components. Based on the nature of the generated electrical output, the electrical bus may be a direct current (DC) bus (as depicted) or an alternating current (AC) bus. The alternator may be connected in series to one or more rectifiers that convert the alternator's electrical output to DC electrical power prior to transmission along the DC bus 117, 217. Based on the configuration of a downstream electrical component receiving power from the DC bus, one or more inverters may be configured to invert the electrical power from the electrical bus prior to supplying electrical power to the downstream component.

Traction motors mounted on a truck below the rail vehicle provide tractive power for propulsion. In one example, as depicted herein, six inverter-traction motor pairs may be provided for each of six axle-wheel pairs 120 of each rail vehicle 10, 12. The traction motors are also configured to act as generators providing dynamic braking to brake the rail vehicle. In particular, during dynamic braking, each traction motor provides torque in a direction that is opposite from the torque required to propel the rail vehicle in the rolling direction thereby generating electricity. A multitude of motor driven airflow devices may be operated for temperature control of rail vehicle components. The airflow devices may include, but are not limited to, blowers, radiators, and fans. For example, traction motor fans may be provided for cooling the traction motors powering the wheels.

At least a portion of the electrical power generated by engine 102, 202 can be routed to a system electrical energy storage device, such as battery 106, 206 linked to DC bus 117, 217, respectively. A DC-DC converter (not shown) may be configured between DC bus 117, 217 and battery 106, 206 to allow the high voltage of the DC bus (for example in the range of 1000V) to be stepped down appropriately for use by the battery (for example in the range of 12-75V). In the case of a hybrid rail vehicle, the on-board electrical energy storage device may be in the form of high voltage batteries, such that the placement of an intermediate DC-DC converter may not be necessitated. The battery 106, 206 may be charged by running engine 102, 202. The electrical energy stored in the battery may be used during a stand-by mode of engine operation, or when the engine is shut down, to operate various electronic components such as lights, on-board monitoring systems, microprocessors, processor displays, climate controls, and the like. Battery 106, 206 may also be used to provide an initial charge to start-up engine 102, 202 from a shut-down condition. In alternate embodiments, the electrical energy storage device may be a super-capacitor, for example.

Each rail vehicle 10, 12 may further include a pressure-actuated brake system 110, 210. In the depicted example, both rail vehicles are older rail vehicles with non-integrated pressure-actuated air brake systems. However, in alternate embodiments, one or more of rail vehicles 10, 12 may be newer rail vehicles including integrated electronic air brake systems. Brake systems 110, 210 may be coupled to respective pressure reservoirs 108, 208 that store compressed air generated from intake air by respective compressors 104, 204.

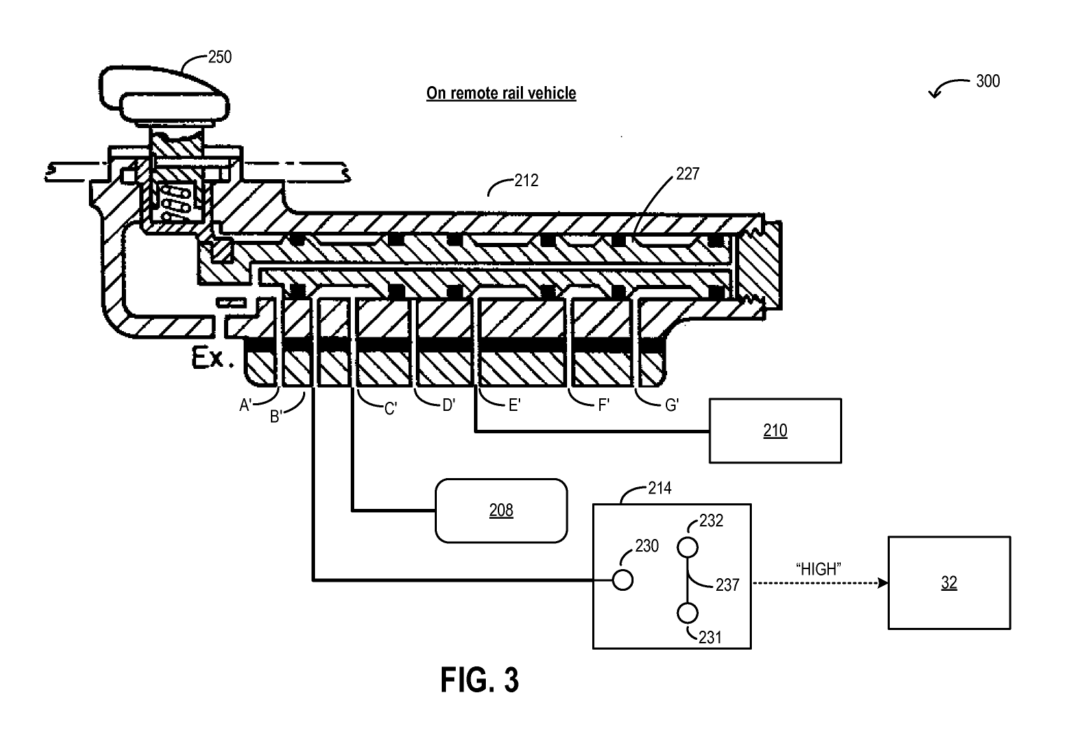

The first rail vehicle 10 includes a first mechanically-adjustable valve 112, and the second rail vehicle 12 includes a second mechanically-adjustable valve 212. First and second mechanically-adjustable valves 112, 212 each have a plurality of positions including at least a first position (e.g., a first lead position) and a second position (e.g., a second remote position). A position of the mechanically-adjustable valve 112, 212 can be mechanically set, for example, manually set by a vehicle operator via a valve knob based on the operational status of the rail vehicle in train consist 8. In one embodiment, as elaborated in FIGS. 2-3, the mechanically-adjustable valves 112, 212 are multi-unit spool valves with a spool and a plurality of ports, with at least one of the plurality of ports of each valve selectively and fluidly coupled to respective pressure reservoir 108, 208. Each of the mechanically adjustable valves is further coupled to a sensor, herein depicted as pressure switch 114, 214, via at least another of the plurality of ports.

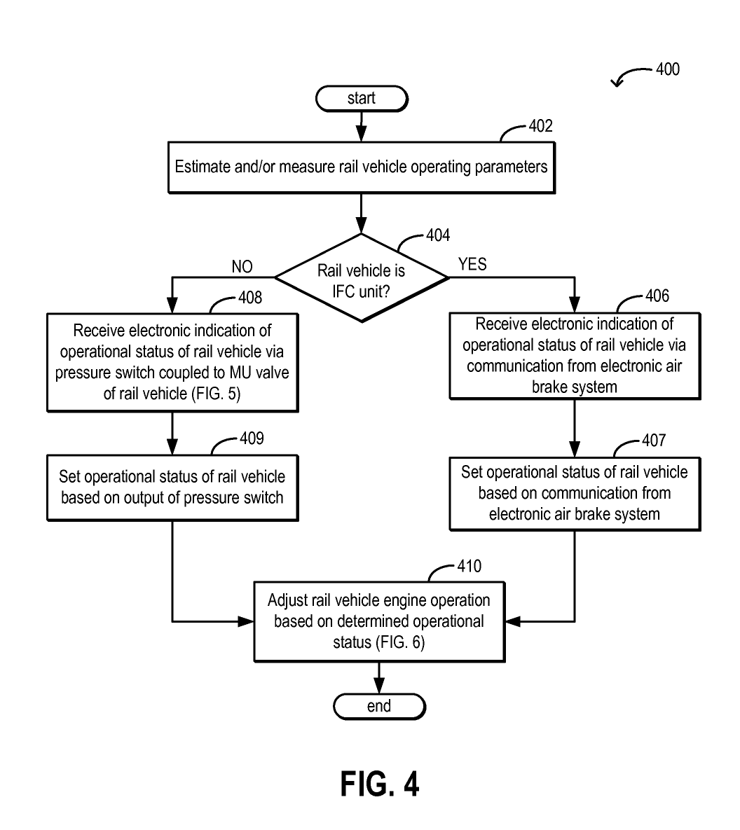

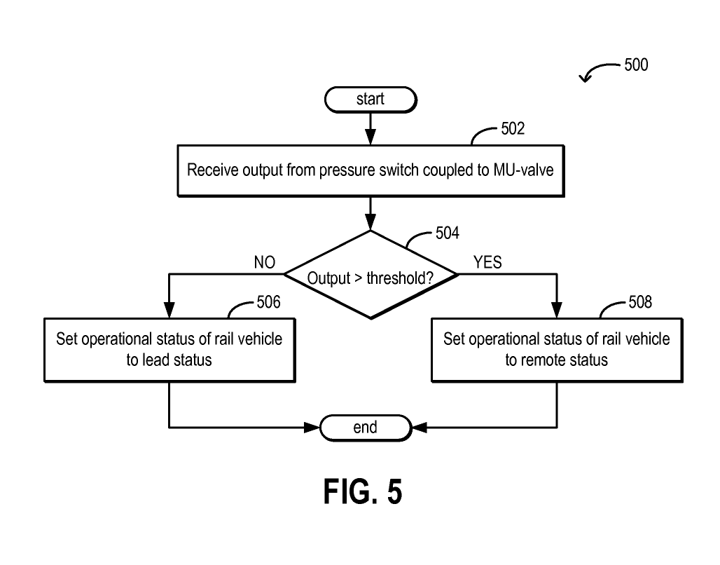

Based on the position of the mechanically-adjustable valve 112, 212, a port of the mechanically-adjustable valve 112, 212 is either fluidly coupled to or decoupled from pressure reservoir 108, 208. An output of the sensor (that is, pressure switch 114, 214) varies based on the current position and/or pressure of the respective mechanically-actuated valve. For example, the output of the sensor may be a first output (e.g., lower than a threshold) when the mechanically-adjustable valve 112, 212 is in the first (e.g., lead) position, while the output may be a second, different output (e.g., higher than a threshold) when the mechanically-adjustable valve 112, 212 is in the second (e.g., remote) position. The sensors (herein, pressure switch 114, 214) are coupled to respective on-board controller 22, 32. The controllers 22, 32 positioned in the respective rail vehicles are configured to set an operational status (e.g., configured with code for setting a flag corresponding to the operational status) of the respective rail vehicle 10, 12 based on the output received from the respective sensors. For example, as elaborated in FIGS. 4-5, controller 22, 32 is configured to set an operational status flag (P1, P2) of the respective rail vehicle to one of a lead operational status or a remote operational status based on whether the output of the respective pressure switch 114, 214 is higher or lower than a threshold. In this way, a mechanically-adjusted setting of a rail vehicle is electronically communicated to the on-board controller of the rail vehicle via a mechanically-adjustable valve and a coupled sensor.

While the depicted example illustrates the sensor as a pressure switch, in alternate embodiments, a sensor that senses the mechanical position of the mechanically-adjustable valve may be additionally or optionally used.

Mechanically-adjustable valve 112, 212 may be further coupled to one or more different pressure-actuated systems of the rail vehicle, such as brake system 110, 210. A pressure setting of brake system 110, 210 may also be based on the position of mechanically-adjustable valve 112, 212. For example, when mechanically-adjustable valve 112, 212 is in the first lead position, the pressure setting of the brake system may be at a higher setting, while when mechanically-adjustable valve 112, 212 is in the second remote position, the pressure setting of the brake system may be at a lower setting. Herein, the higher pressure setting of the brake system in the lead position ensures a higher braking authority for a lead rail vehicle, as compared to a remote rail vehicle.

In one example, pressure reservoirs 108, 208 are refillable pressure reservoirs. A pressure of the pressure reservoir may be determined by a pressure sensor (not shown) coupled to each pressure reservoir. Controllers 22, 32 may be configured for refilling pressure reservoir 108, 208 with compressed air, for example, from compressors 104, 204, when a pressure of the pressure reservoir 108, 208 falls below a threshold pressure value.

Controllers 22, 32 may be further configured for adjusting engine operations (e.g. automatic engine shut down and restart operations) of the respective rail vehicle 10, 12 based on the operational status (P1, P2) of the rail vehicle 10, 12. For example, parameter thresholds at which the engine 102, 202 of the rail vehicle 10, 12 is automatically shut down or restarted are adjusted based on the operational status. This includes raising parameter thresholds when the operational status is set to a lead status, and lowering parameter thresholds when the operational status is set to a remote status.

In response to AESS instructions, the on-board controller 22, 32 may control a respective engine 102, 202 by sending a command to various engine control hardware components such as system inverters, alternators, relays, fuel injectors, fuel pumps, etc. On-board controller 22, 32 may monitor operating parameters in an idle rail vehicle 10, 12. Upon verifying that AESS criteria are met, for example in response to operating parameters exceeding a predetermined threshold (or falling within a desired range of values), the on-board controller 22, 32 may execute code to appropriately auto-stop engine 102, 202 by enabling an AESS routine, as further elaborated in FIG. 6. Further still, the on-board controller 22, 32 may monitor locomotive operating parameters in shutdown rail vehicle 10, 12, and in response to operating parameters falling below the desired range, the on-board controller 22, 32 may execute code to appropriately auto-start engine 102, 202.

It will be appreciated that while the depicted example shows the first and second rail vehicles as older rail vehicles with non-integrated air brake systems, in alternate embodiments, one or more of the rail vehicles in the train system may be a newer rail vehicle including an integrated electronic air brake system communicatively coupled to the on-board controller. Therein, the controller may be configured to set the operational status of the rail vehicle in the train consist based on communication received from the integrated electronic air brake system.

Now turning to FIG. 2, an example embodiment 200 of a first mechanically-adjustable valve 112 coupled to a first pressure switch 114 and a first pressure reservoir 108 of a first lead rail vehicle 10 of FIG. 1 is illustrated.

In the depicted example, the first mechanically-adjustable valve 112 is a spool valve having a spool 127 and a plurality of ports A-G. First mechanically-adjustable valve 112 has a plurality of positions including at least a first (e.g., lead) position and a second (e.g., remote) position. A vehicle operator can manually set the position of mechanically-adjustable valve 112 to either the first or the second position by adjusting knob 150. In the depicted embodiment, first mechanically-adjustable valve 112 is in the first position.

A first of the plurality of ports, herein port C, is selectively coupled to first pressure reservoir 108. The first port, port C, is in fluid communication with a second port, herein port B, via the spool 127 of the spool valve. The second port, port B, is in turn fluidly coupled to first pressure switch 114. Based on the position of first mechanically-adjustable valve 112, port C is either fluidly coupled to or decoupled from first pressure reservoir 108. Accordingly, a pressure relayed from port C to port B is varied, and a pressure sensed by first pressure switch 114 is varied. As shown in the depicted embodiment, when first mechanically-adjustable valve 112 is set to the first position, air piped from first pressure reservoir 108 to port C is blocked by spool 127, thereby fluidly decoupling port C from first pressure reservoir 108. At the same time ports A and B are connected to the atmosphere (herein, also referred to as “exhaust”). The falling pressure at port B is sensed by first pressure switch 114 and accordingly an output of first pressure switch 114 is adjusted. In comparison, when first mechanically-adjustable valve 112 is set to a second position, air is piped from first pressure reservoir 108 to port C unobstructed, thereby fluidly coupling port C to first pressure reservoir 108. Since port B is fluidly coupled to port C, the air is further relayed to port B via spool 127. At the same time, only port A is connected to the atmosphere (or “exhaust”). The rising pressure at port B is sensed by first pressure switch 114 and accordingly an output of first pressure switch 114 is adjusted. In one example, in the first position of the valve, the pressure at the port corresponds to a first (e.g., lower) pressure, while in the second position of the valve, the pressure at the port corresponds to a second, different (e.g., higher) pressure of the pressure reservoir.

First pressure switch 114 includes three contacts 130, 131, 132. In the depicted example, contact 130 provides an electrical connection to first mechanically-adjustable valve 112 (via port. B), contact 131 provides an electrical connection to controller 22, and contact 132 provides an electrical connection to a power source (such as, a battery). Based on the pressure sensed by the pressure switch at port B, a position of switch interlock 137 is adjusted. Specifically, when mechanically-adjustable valve 112 is in the first position (as shown), in response to the falling pressure at port B, contacts 130 and 132 are connected, and a lower output (such as a lower voltage output, e.g., 0V) is output from first pressure switch 114 to first controller 22. In the depicted example, the lower output relayed from the pressure switch to the controller is illustrated as “LOW” reflecting the output of the first pressure switch 114 being low relative to a predetermined threshold. Based on the output of the first pressure switch 114, controller 22 may set the operational status of the first rail vehicle to one of a lead or a remote status. In the depicted example, the controller sets the operational status to a lead status in response to the output of the pressure switch being lower than a threshold. As elaborated in FIG. 6, controller 22 may be further configured to adjust engine operations (e.g., adjust automatic engine shutdown and restart operations) of the first rail vehicle based on the operational status of the rail vehicle.

First mechanically-adjustable valve 112 further includes at least a third port, herein port E, fluidly coupled to the pressure-actuated brake system 110 of the rail vehicle. In some embodiments, the pressure-actuated brake system 110 of the first rail vehicle is further fluidly coupled to first pressure reservoir 108, to provide component sharing benefits. A pressure setting of the first brake system 110 may be based on the position of first mechanically-adjustable valve 112. Specifically, when first mechanically-adjustable valve 112 is in the first position (as depicted), the pressure setting of the brake system is set at a higher setting. As such, since the first position of the mechanically-adjustable valve 112 correlates with a lead operational status, by setting a higher setting for the brake system, a higher braking authority is maintained on a lead rail vehicle.

Now turning to FIG. 3, an example embodiment 300 of a second mechanically-adjustable valve 212 coupled to a second pressure switch 214 and a second pressure reservoir 208 of a second (remote) rail vehicle 12 of FIG. 1 is illustrated.

In the depicted example, second mechanically-adjustable valve 212 is also a spool valve having a spool 227 and a plurality of ports A′-G′. Second mechanically-adjustable valve 212 also has a plurality of positions including at least a first (e.g., lead) position and a second (e.g., remote) position. A vehicle operator can manually set the position of mechanically-adjustable valve 212 to either the first or the second position by adjusting knob 250. In the depicted embodiment, second mechanically-adjustable valve 212 is in the second position corresponding to the remote status.

A first of the plurality of ports, herein port C′, is selectively fluidly coupled to second pressure reservoir 208. The first port, port C′, is in fluid communication with a second port, herein port via the spool 227 of the spool valve. The second port, port B′, is in turn fluidly coupled to second pressure switch 214. Based on the position of second mechanically-adjustable valve 212, port C′ is either fluidly coupled to or decoupled from second pressure reservoir 108. Accordingly, a pressure relayed from port C′ to port B′ is varied, and a pressure sensed by second pressure switch 214 is varied. As shown in the depicted embodiment, when second mechanically-adjustable valve 212 is set to the second position, air is piped from second pressure reservoir 208 to port C′ unobstructed, thereby fluidly coupling port C′ to second pressure reservoir 208. Since port B′ is further fluidly coupled to port C′, the air is further relayed to port B′ via spool 227. At the same time, only port A′ is connected to the atmosphere (or “exhaust”). The rising pressure at port B′ is sensed by second pressure switch 214 and accordingly an output of second pressure switch 214 is adjusted. In one example, in the first position of the valve, the pressure at the port corresponds to a first (e.g., lower) pressure, while in the second position of the valve, the pressure at the port corresponds to a second, different (e.g., higher) pressure of the pressure reservoir.

Second pressure switch 214 includes three contacts 230, 231, 232, having connections similar to those of first pressure switch 114 (elaborated previously). Based on the pressure sensed by the pressure switch 214 at port 13′, a position of switch interlock 237 is adjusted. Specifically, when mechanically adjustable valve 212 is in the second position (as shown), in response to the rising pressure at port B′ (e.g., pressure at or above 18±3 psi), contacts 231 and 232 are connected, and a higher output (such as a higher voltage output, e.g., 74V) is output from second pressure switch 214 to second controller 32. In the depicted example, the higher output received from the pressure switch at the controller is illustrated as “HIGH” reflecting the output of the second pressure switch 214 being high relative to a predetermined threshold. Based on the output of the second pressure switch 214, controller 32 may set an operational status of the second rail vehicle to one of a lead or a remote status. In the depicted example, the controller sets the operational status to a remote status in response to the output of the pressure switch being higher than a threshold. As elaborated in FIG. 6, controller 32 may further adjust engine operations (e.g., adjusting automatic engine shutdown and restart operations) of the second rail vehicle based on the operational status of the rail vehicle.

Second mechanically-adjustable valve 212 further includes at least a third port, herein port E′, coupled to the pressure-actuated brake system 210 of the rail vehicle. Pressure-actuated brake system 210 of the second rail vehicle may be further coupled to second pressure reservoir 208, to provide component sharing benefits. A pressure setting of the second brake system 210 may be based on the position of second mechanically-adjustable valve 212. Specifically, when second mechanically-adjustable valve 212 is in the second position (as depicted), the pressure setting of the brake system is set at a lower setting. As such, since the second position of the mechanically-adjustable valve 212 correlates with a remote operational status flag, by setting a lower setting for the brake system, a higher braking authority is ensured on the lead rail vehicle.

Now turning to FIG. 4, an example routine 400 is described for setting an operational status of a rail vehicle (e.g., locomotive) in a consist (e.g., train consist), and adjusting engine operations (e.g., AESS operations) of the rail vehicle accordingly.

At 402, rail vehicle operating parameters for a rail vehicle in a consist may be estimated and/or measured. The parameters may include, for example, one or more of a battery state of charge, engine oil temperature, ambient temperature, exhaust temperature, vehicle load, compressor air pressure, main air reserve pressure, battery voltage, a battery state of charge and brake cylinder pressure, etc. At 404, it may be determined whether the rail vehicle is an WC unit. That is, it may be confirmed whether the rail vehicle is configured with integrated function control features, such as integrated electronic air brake (EAB) systems that are communicatively coupled to a controller. If yes, then at 406, the controller may receive (e.g., automatically) an electronic indication, or communication, regarding the operational status of the rail vehicle in the consist from the EAB system of the rail vehicle. Accordingly, at 407, the controller may set the operational status (e.g., an operational status flag) of the rail vehicle in the consist based on the communication from the integrated electronic air brake system.

In comparison, if the rail vehicle is not an IFC unit, that is, the rail vehicle is not configured with integrated function software features, and has a non-integrated air brake system instead, at 408, the controller may receive an electronic indication regarding the operational status of the rail vehicle in the consist from a sensor coupled to a mechanically-adjustable valve in the rail vehicle. As such, the mechanically-adjustable valve may have a plurality of positions including at least a first and a second position. As elaborated in FIG. 5, the controller may receive an output (e.g., voltage output) from the sensor (e.g., pressure switch), the output of the sensor based on the current position and/or pressure of the mechanically-adjustable valve. Accordingly, at 409, the controller may set the operational status of the rail vehicle in the consist based on the output of the sensor coupled to the mechanically-adjustable valve of the rail vehicle. For example, the controller may include code for setting a flag corresponding to the operational status of the rail vehicle.

At 410, engine operations for the rail vehicle may be adjusted based on the operational status of the rail vehicle. As elaborated in FIG. 6, this includes adjusting automatic engine shutdown and restart operations of the rail vehicle based on the operational status of the rail vehicle. As one example, this may include adjusting parameter thresholds at which the engine of the rail vehicle is automatically restarted and shutdown (e.g., parameter thresholds for a lead rail vehicle may be raised while thresholds for a remote rail vehicle may be lowered). The parameters may include one or more of air pressure, battery state of charge, and temperature. As another example, this may include enabling/disabling a set of features (such as, premium AESS features) based on the set operational status of the rail vehicle (e.g., premium features may be enabled on the lead rail vehicle while premium features may be disabled on the remote rail vehicle, or vice versa).

Now turning to FIG. 5, an example routine 500 is described for setting an operational status of the rail vehicle based on the output of a pressure switch coupled to a mechanically-adjustable valve of the rail vehicle. In one example, the routine of FIG. 5 may be performed as part of the routine of FIG. 4, specifically at 408. As such, the routine of FIG. 5 may be performed in a rail vehicle that does not include an integrated electronic air brake system.

At 502, the routine includes receiving an output from the pressure switch coupled to the mechanically-adjustable valve of the rail vehicle. In one example, the output is a voltage output. At 504, the output is compared to a threshold output to determine if the output of the pressure switch is greater than the threshold. If the output of the pressure switch is lower than the threshold, then at 506, the routine includes the controller setting the operational status (e.g., an operational status flag) of the rail vehicle to a lead status. In comparison, when the output of the pressure switch is higher than the threshold, at 508, the routine includes the controller setting the operational status of the rail vehicle to a remote status.

While the depicted example illustrates setting the operational status of the rail vehicle based on a comparison of the voltage output of the pressure switch with reference to a threshold voltage, in an alternate example, the output of the pressure switch may include an electronic indication of “HIGH” or “LOW” based on whether the pressure of the port, as sensed, is higher or lower than an indicated threshold pressure setting. Herein, the controller may set the operational status flag of the rail vehicle to a lead status when the electronic indication output from the pressure switch is “LOW” (e.g., lower than a threshold), and may set the operational status of the rail vehicle to a remote status when the electronic indication output from the pressure switch is “HIGH” (e.g., higher than a threshold). Still other outputs may be possible.

It will be appreciated that while the depicted example illustrates a lower output of the pressure switch when the mechanically-adjustable valve is in the first position and a higher output of the pressure switch when the mechanically-adjustable valve is in the second position, in alternate examples, the pressure switch may be configured such that a higher output is relayed from the pressure switch when the mechanically-adjustable valve is in the first position and a lower output is relayed from the pressure switch when the mechanically-adjustable valve is in the second position. In still other embodiments, such as where the pressure switch includes a pressure meter, the operational status of the rail vehicle may be set based on whether an absolute pressure output by the switch is higher or lower than a threshold pressure setting. Further, while the depicted example illustrates the sensor as a pressure switch, in alternate embodiments, a sensor that senses the mechanical position of the mechanically-adjustable valve may be used.

Now turning to FIG. 6, an example routine 600 is shown for adjusting an engine AESS operation of a rail vehicle (e.g., locomotive) based on the operational status of the vehicle. As such, engine AESS operations may be performed by an on-board controller during a stand-by or shut-down mode of rail vehicle operation. In one example, the rail vehicle may be in a stand-by mode when parked on a siding for a long term with the engine running at an idling speed, and with an on-board controller maintained active. In another example, the rail vehicle may be shifted to a stand-by mode after a threshold duration (e.g., 4000 hours) of engine operation. In the shut-down mode, the rail vehicle may be stationary and parked, and further the engine may not be running. However, on-board electronics, such as the on-board controller, of the rail vehicle are maintained active during the shut-down conditions. The AESS routine 600 may allow monitoring of a plurality of operating parameters to verify that they are at a desired condition. If the AESS criteria are met, and the engine is running, the engine may then be automatically shut-down, thereby reducing the idling time of the rail vehicle engine, and providing fuel economy and reduced emission benefits. In contrast, during vehicle shut-down conditions, a plurality of engine operating parameters may be monitored and further, the engine may be automatically started in response to any of the plurality of monitored operating conditions falling outside a respective desired condition. The engine may be stopped when the operating condition regains the desired condition. By maintaining the vehicle operating parameters in an operation ready-state at all times, rail vehicle efficiency can be improved.

Routine 600 includes, at 602, determining the operational status of the rail vehicle (e.g., by reading the operational status flag). As elaborated previously with reference to FIGS. 4-5, when the rail vehicle is an IFC unit, an on-board controller may set the operational status of the rail vehicle based on communication received from an integrated electronic air brake system. In comparison, when the rail vehicle is not an IFC unit, the controller may the operational status of the rail vehicle based on the output of a sensor (e.g., pressure switch) coupled to a mechanically-adjustable valve of the rail vehicle, the output based on the current position and/or current pressure of the mechanically-adjustable valve, as set by a vehicle operator.

At 604, based on the operational status setting, the controller may adjust parameter threshold for AESS operations wherein parameter thresholds at which the rail vehicle is automatically restarted or shut down are adjusted based on the operational status of the rail vehicle. In one example, the controller may raise parameter thresholds when the rail vehicle is set to a lead status and may lower parameter thresholds when the rail vehicle is set to a remote status. For example, the controller may set a higher brake pressure threshold for the lead rail vehicle (e.g., at 105 psi) while setting a lower brake pressure threshold for the remote rail vehicle (e.g., at 60 psi). In another example, the controller may select a first set of higher thresholds and/or enable a set of premium AESS features on the rail vehicle when the rail vehicle is set to a lead status. Similarly, the controller may select a second set of lower thresholds and/or disable the set of premium AESS features on the rail vehicle when the rail vehicle is set to a remote status. The thresholds (or set of thresholds) and features corresponding to the different operational status settings of the rail vehicle may be stored in a look-up table in the controller's memory and accessed upon determination of the operational status.

At 606, it may be determined whether the monitored operating parameters (such as those monitored in FIG. 4, at step 402) are at a desired condition, such as within a desired range of values or above a desired threshold value. The parameters monitored may include, for example, one or more of a battery state of charge, ambient temperature, engine oil temperature, compressor air pressure, main air reserve pressure, battery voltage, and brake cylinder pressure. In one example, only one of the plurality of operating parameters may be monitored and used to determine if AESS criteria are met. In another example, some or all of the operating parameters may be concurrently monitored and used to determine if AESS criteria are met. Upon estimating the conditions and verifying whether the parameters are within a prescribed range of desired values, at 608 and 610, it is determined whether the rail vehicle engine is currently running.

If the operating parameter(s) are at the desired condition (that is, in range), and the engine is not currently running, that is the rail vehicle is in a shut-down mode, then at 614, the rail vehicle engine may be maintained in a shut-down mode. However, if the parameters are within range and the engine is currently running, that is the rail vehicle is in a stand-by mode, the engine may be automatically shut-down, or auto-stopped, at 612.

If the parameters are not within the desired range, and the engine is currently running, then at 616, the engine may be kept running to allow the parameters to be brought back to the desired condition. If any of the plurality of monitored operating parameters falls outside their respective desired condition, and further if the engine is not currently running, then at 618, the engine may be automatically started to enable the desired conditions to be regained. It will be appreciated that in alternate examples, the engine may be automatically started when any of the monitored operating parameters fall outside their respective desired conditions. In one example, if the battery charge has dissipated and consequently the battery state of charge has dropped, then the engine may be run to allow the electrical power generated by the engine to be used to recharge the battery and regain a desired battery state of charge. In another example, if the compressor air pressure has fallen below a desired value, then the engine may be run until the compressor is sufficiently full of compressed air and a compressed air storage pressure has been reached. It will be further appreciated that the threshold of a rail vehicle operating parameter at which the engine is automatically started may differ from the threshold at which the engine is automatically shut-down. In one example, the engine may be automatically started when the battery state of charge has dropped below 30%. In contrast, the engine may be run until a battery state of charge of 50% is reached, following which the engine may be automatically shut-down.

In one example, a first on-board controller may automatically shut down or restart the first engine of the first rail vehicle of FIG. 1 in response to a parameter of the of the first rail vehicle reaching a first threshold, the first threshold based on the operational status of the first rail vehicle, while a second on-board controller may automatically shut down or restart the second engine of the second rail vehicle of FIG. 1 in response to a parameter of the of the second rail vehicle reaching a second, different, threshold, the second threshold based on the operational status of the second rail vehicle. For example, when the first controller has set the first rail vehicle to a lead status and the second controller has set the second rail vehicle to a remote status, the first threshold for the first rail vehicle may be set to be higher than the second threshold for the second rail vehicle.

Example rail vehicle system scenarios are now provided to further clarify the concepts previously introduced. In a first example, a train system includes a first older rail vehicle and a second newer rail vehicle. The first older rail vehicle includes a non-integrated air brake system coupled to a pressure reservoir, the pressure reservoir further coupled to a mechanically-adjustable valve having a plurality of positions, including at least a first and a second position. Further, a sensor, such as a pressure switch, is coupled to the mechanically-adjustable valve. An output of the sensor is based on the position and/or pressure of the mechanically-adjustable valve. A first controller positioned in the first rail vehicle and coupled to a first sensor is configured for setting a first operational status of the first rail vehicle in the train system based on the output of the first sensor and adjusting automatic engine shutdown and restart operations of the first rail vehicle based on the first operational status. The second rail vehicle includes an integrated electronic air brake system and a second controller positioned in the second rail vehicle in communication with the integrated electronic air brake system. The second controller in configured for setting a second operational status of the second rail vehicle in the train system based on the communication received from the integrated electronic air brake system and adjusting automatic engine shutdown and restart operations of the second rail vehicle based on the second operational status.

The first controller setting the first operational status based on the output of the pressure switch includes setting the first operational status to a lead status when the output of the pressure switch is lower than a threshold, and setting the first operational status to a remote status when the output of the pressure switch is higher than the threshold. The second controller setting the second operational status based on communication with the integrated electronic air brake system includes setting the second operational status to a lead status when the integrated electronic air brake system communicates a lead status, and setting the second operational status to a remote status when the integrated electronic air brake system communicates a remote status.

Each controller further adjusts automatic engine shutdown and restart operations of the respective rail vehicle based on the corresponding operational status flag by raising parameter thresholds at which an engine of the rail vehicle is automatically shut down or restarted when the rail vehicle is set to a lead status, and lowering parameter thresholds at which the engine is automatically shut down or restarted when the rail vehicle is set to a remote status.

In another example, both the first and second rail vehicles are older rail vehicles lacking integrated electronic air brake systems capable of communicating with a rail vehicle controller. Herein, each rail vehicle includes a mechanically-adjustable valve coupled to a sensor (e.g., pressure switch) and a pressure reservoir. A controller positioned in each rail vehicle and coupled to respective sensors includes code for setting an operational status of the rail vehicle in the train consist based on the output of the respective sensor. Further, the controller adjusts automatic engine shutdown and restart operations of the corresponding rail vehicle based on the operational status.

Now turning to FIG. 7, it depicts another embodiment related to a rail vehicle system 700. The system 700 includes an input module 702 and a control module 704. Control module 704 is operatively coupled to the input module 702. The input module 702 is configured for deployment in a rail vehicle 706, and is further configured to receive a first signal 708 relating to a current position and/or a current pressure of a mechanically-adjustable valve 710 in the rail vehicle 706. Herein, the current pressure is a pressure associated with the valve, such as a pressure present at a port of the valve, a pressure within the valve, or the like. The control module 704 is configured to generate a second signal 712, which is used for adjusting automatic engine shutdown and restart operations of the rail vehicle 706. The second signal 712 is based on the first signal 708, and is indicative of an operational status of the rail vehicle 706 as a lead rail vehicle or a remote rail vehicle in a consist.

To explain further, as an example, the first signal 708 will have first and second different states, based on the current position and/or current pressure of the mechanically-adjustable valve 710. That is, for a first position and/or pressure of the valve, the first signal is at the first state, and for a second, different position and/or pressure of the valve, the first signal is at the second, different state. In one example, the first position and/or pressure of the valve, and therefore the first state of the first signal, corresponds to a lead operational status of the rail vehicle in a consist. Similarly, the second position and/or pressure of the valve, and therefore the second state of the first signal, corresponds to a remote operational status of the rail vehicle in the consist. The second signal 712, generated by the control module 704, is based on the first signal, and is indicative of the rail vehicle being in the remote status or the lead status. The second signal may be transmitted to an engine system or other system 714 in the rail vehicle.

Each module 702, 704 may be a hardware and/or software module, configured for carrying out the indicated functionality when deployed on a vehicle, e.g., when interfaced with an electronic component or other system of the vehicle. Herein, “software” refers to code/instructions, embodied in a tangible medium, which are executable by a controller or other control element for performing a designated function, according to the content of the code/instructions. The indicated functionality may be carried out by the module itself, or in conjunction with other vehicle system elements under the control of, or as reconfigured by, the module. For example, the control module may be a stand-alone hardware and/or software module that can be interfaced with a vehicle engine control system or an AESS system, or it can be part of the vehicle engine control system or AESS system.

In one embodiment, the first signal 708 is an output of a sensor that is operably attached to the mechanically-adjustable valve 710 for sensing the current position and/or current pressure of the valve. For example, the sensor may be a pressure switch for sensing a pressure that is present at a port of the valve, with the pressure being dependent on the current position of the valve.

In this way, by setting an operational status of a rail vehicle based on the output of a sensor coupled to a mechanically-adjusted valve of the rail vehicle, engine operations for a rail vehicle can be tailored based on the operational status of the rail vehicle, even if the rail vehicle is not equipped with integrated control features, such as integrated electronic air brake systems. In doing so, vehicle operations may be improved. For example, by adjusting parameter thresholds for AESS operations on each rail vehicle's engine based on the operational status of the rail vehicle in the consist, fuel savings and emissions reduction benefits can be availed on all the rail vehicles.

Unless otherwise specified (such as in the claims), embodiments of the invention are applicable to rail vehicles generally, and/or to vehicles with diesel engines. Thus, any instances of “locomotive” herein refer more generally to a rail vehicle or other vehicle, unless otherwise specified. The term “lead” rail vehicle as used herein refers to a rail vehicle designated for primary control of a rail vehicle consist, and not necessarily to the first rail vehicle in the consist. However, in some operational modes, the lead rail vehicle may be the first rail vehicle in the rail vehicle consist. “Remote” or “trail” rail vehicle as used herein refers to a rail vehicle set to take a subordinate role in consist control, e.g., a remote or trail rail vehicle controlled based on control signals received from the lead rail vehicle, such as in distributed power operations.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims. Moreover, unless specifically stated otherwise, any use of the terms first, second, etc., do not denote any order or importance, but rather the terms first, second, etc. are used to distinguish one element from another.

1. A rail vehicle system, comprising:
a mechanically-adjustable valve coupled in a rail vehicle, the mechanically-adjustable valve having a plurality of positions;
a pressure switch coupled to the mechanically-adjustable valve, an output of the pressure switch based on a current position of the mechanically-adjustable valve; and
a controller positioned in the rail vehicle and coupled to the pressure switch, the controller configured for setting an operational status of the rail vehicle in a consist based on the output of the pressure switch.

2. The rail vehicle system of claim 1, wherein the mechanically-adjustable valve is a spool valve with a plurality of ports including a first port in communication with a second port, the first port selectively coupled to a pressure reservoir, the second port coupled to the pressure switch, and wherein the controller setting an operational status includes the controller setting a flag corresponding to the operational status of the rail vehicle to one of a lead status or a remote status based on the output of the pressure switch.

3. The rail vehicle system of claim 2, wherein the mechanically-adjustable valve includes a first position and a second position, the first port of the mechanically-adjustable valve fluidly decoupled from the pressure reservoir when the mechanically-adjustable valve is in the first position, and the first port of the mechanically-adjustable valve fluidly coupled to the pressure reservoir when the mechanically-adjustable valve is in the second position.

4. The rail vehicle system of claim 3, wherein the output of the pressure switch includes a lower output when the mechanically-adjustable valve is in the first position and a higher output when the mechanically-adjustable valve is in the second position.

5. The rail vehicle system of claim 3, wherein the mechanically-adjustable valve further includes a third port coupled to a pressure-actuated brake system of the rail vehicle, the pressure-actuated brake system further coupled to the pressure reservoir, a pressure setting of the pressure-actuated brake system based on the first or second position of the mechanically-adjustable valve.

6. The rail vehicle system of claim 5, wherein the pressure setting of the pressure-actuated brake system is at a higher setting when the mechanically-adjustable valve is in the first position, and wherein the pressure setting of the pressure-actuated brake system is at a lower setting when the mechanically-adjustable valve is in the second position.

7. The rail vehicle system of claim 2, wherein setting the flag corresponding to the operational status of the rail vehicle based on the output of the pressure switch includes, setting the flag to the lead status when the output of the pressure switch is lower than a threshold, and setting the flag to the remote status when the output of the pressure switch is higher than the threshold.

8. The rail vehicle system of claim 2, wherein the controller is further configured for adjusting engine operations of the rail vehicle based on the flag corresponding to the operational status of the rail vehicle.

9. The rail vehicle system of claim 8, wherein adjusting engine operations include adjusting automatic engine shutdown and restart operations of the rail vehicle.

10. The rail vehicle system of claim 9, wherein adjusting automatic engine shutdown and restart operations includes raising parameter thresholds at which an engine of the rail vehicle is automatically shut down or restarted when the flag is set to the lead status, and lowering parameter thresholds at which the engine is automatically shut down or restarted when the flag is set to the remote status.

11. The rail vehicle system of claim 2, wherein a pressure of the pressure reservoir is determined by a pressure sensor coupled to the pressure reservoir, the controller further configured for refilling the pressure reservoir with compressed air from a compressor when the pressure of the pressure reservoir is below a threshold.

12. A rail vehicle system, comprising:
an input module configured for deployment in a rail vehicle and further configured to receive a first signal relating to a current position and/or a current pressure of a mechanically-adjustable valve in the rail vehicle; and
a control module operatively coupled to the input module and configured to generate a second signal for adjusting automatic engine shutdown and restart operations of the rail vehicle, wherein the second signal is indicative of an operational status of the rail vehicle as a lead rail vehicle or a remote rail vehicle in a consist, based on the first signal.

13. A method of operating a consist having a rail vehicle, the method comprising:
receiving an output from a sensor, wherein the output is based on a current position and/or a current pressure of a mechanically-adjustable valve in the rail vehicle;
setting an operational status of the rail vehicle in the consist to one of a lead status or a remote status based on the output of the sensor; and
adjusting automatic engine shutdown and restart operations of the rail vehicle based on the operational status.

14. The method of claim 13, wherein:
the sensor is a pressure switch coupled to the mechanically-adjustable valve;
the output of the pressure switch is based on a pressure present at a port of the valve;
in a first position of the valve, a pressure reservoir is fluidly decoupled from the port, and the pressure present at the port corresponds to a first pressure; and
in a second position of the valve, the pressure reservoir is fluidly coupled to the port, and the pressure present at the port is a second, different pressure of the pressure reservoir.

15. The method of claim 14, wherein the valve is coupled to a pressure-actuated brake system of the rail vehicle, the pressure-actuated brake system further coupled to the pressure reservoir, a pressure setting of the pressure-actuated brake system based on the current position of the mechanically-adjustable valve, the pressure setting including a higher pressure setting when the mechanically-adjustable valve is in the first position, and a lower pressure setting when the mechanically-adjustable valve is in the second position.

16. The method of claim 13, wherein the sensor is a pressure switch coupled to the mechanically-adjustable valve, and wherein setting the operational status based on the output of the pressure switch includes, setting the operational status to the lead status when the output of the pressure switch is lower than a threshold, and setting the operational status to the remote status when the output of the pressure switch is higher than the threshold.

17. The method of claim 13, wherein adjusting automatic engine shutdown and restart operations of the rail vehicle includes, raising parameter thresholds at which an engine of the rail vehicle is automatically shut down or restarted when the operational status is set to a lead status, and lowering parameter thresholds at which the engine is automatically shut down or restarted when the operational status is set to a remote status, the parameter including one or more of air pressure, battery state of charge, and temperature.

18. A train system, comprising:
a first rail vehicle including a mechanically-adjustable valve having a plurality of positions;
a pressure switch coupled to the mechanically-adjustable valve, an output of the pressure switch based on the position of the mechanically-adjustable valve;
a first controller positioned in the first rail vehicle and coupled to the pressure switch, the first controller including code for,
setting a first operational status flag corresponding to a first operational status of the first rail vehicle in the train system based on the output of the pressure switch; and
adjusting automatic engine shutdown and restart operations of the first rail vehicle based on the first operational status flag;
a second rail vehicle including an integrated electronic air brake system; and
a second controller positioned in the second rail vehicle in communication with the integrated electronic air brake system, the second controller including code for,
setting a second operational status flag corresponding to a second operational status of the second rail vehicle in the train system based on the communication with the integrated electronic air brake system; and
adjusting automatic engine shutdown and restart operations of the second rail vehicle based on the second operational status flag.

19. The train system of claim 18, wherein the first controller setting the first operational status flag based on the output of the pressure switch includes, setting the first operational status flag to a lead operational status when the output of the pressure switch is lower than a threshold, and setting the first operational status flag to a remote operational status when the output of the pressure switch is higher than the threshold, and further wherein the second controller setting the second operational status flag based on communication with the integrated electronic air brake system includes, setting the second operational status flag to a lead operational status when the integrated electronic air brake system communicates a lead operational status, and setting the second operational status flag to a remote operational status when the integrated electronic air brake system communicates a remote operational status.

20. The train system of claim 19, wherein adjusting automatic engine shutdown and restart operations of the first rail vehicle based on the first operational status flag includes raising parameter thresholds at which an engine of the first rail vehicle is automatically shut down or restarted when the first operational status flag is set to the lead operational status, and lowering parameter thresholds at which the engine is automatically shut down or restarted when the first operational status flag is set to the remote operational status, and wherein adjusting automatic engine shutdown and restart operations of the second rail vehicle based on the second operational status flag includes raising parameter thresholds at which an engine of the second rail vehicle is automatically shut down or restarted when the second operational status flag is set to the lead operational status, and lowering parameter thresholds at which the engine is automatically shut down or restarted when the second operational status flag is set to the remote operational status, the parameters including one or more of air pressure, battery state of charge, and temperature.

21. The train system of claim 18, wherein the first rail vehicle further includes a non-integrated air brake system, the non-integrated air brake system coupled to a pressure reservoir, the pressure reservoir further coupled to the mechanically-adjustable valve.
